(19) United States
(12) Patent Application Publication
(10) Pub. No.: US 2023/0322092 A1
(43) Pub. Date: Oct. 12, 2023

(54) ELECTRICALLY OPERATED BRAKING ASSEMBLY FOR A BRAKING SYSTEM OF A MOTOR VEHICLE

(71) Applicant: ZF Active Safety GmbH, Koblenz (DE)

(72) Inventors: Werner Seibert, Kammerforst (DE); Rabisankar Panda, Hyderabad (IN); Prashant Patel, Hyderabad (IN)

(21) Appl. No.: 18/188,956

(22) Filed: Mar. 23, 2023

(30) Foreign Application Priority Data
Mar. 28, 2022 (DE) 102022107296.7

(51) Int. Cl. B60L 7/00

(52) U.S. Cl. CPC B60L 7/003

(57) ABSTRACT

Described herein is an electrically operated assembly for a braking system of a motor vehicle, having a brake force generator and a control unit, by which the brake force generator can be controlled. The brake force generator has a brake force generator housing, to which a control housing, in which the control unit is accommodated, is attached directly adjacently to a side of the brake force generator housing. In addition, the brake force generator has an electric motor with a stator. The stator is received, together with stator windings, in the control housing.

### CROSS-REFERENCE TO RELATED APPLICATION

This application claims priority to German Priority Application No. 102022107296.7, filed Mar. 28, 2022, the disclosure of which is incorporated herein by reference in its entirety.

### TECHNICAL FIELD

The disclosure relates to an electrically operated braking assembly for a braking system of a motor vehicle.

### BACKGROUND

Electrically operated braking assemblies are part of braking systems in motor vehicles, wherein a braking system usually has service brakes, usually electrohydraulically or electromechanically actuated brakes, and/or parking brakes, usually electromechanically actuated brakes.

The electrically operated braking assemblies have a brake force generate, which usually has either an electrohydraulic or an electromechanical operating principle.

The brake force generator converts electrical energy into mechanical energy and this allows so-called “brake-by-wire” technology. In the event of a braking procedure, a contact pressure is exerted against at least one brake pad of a vehicle brake as a result of the energy conversion and is then supported at a brake disc.

For example, this contact pressure can be generated by an electromechanical spindle drive and introduced into the brake pads. Such an arrangement is often used as a parking brake (EPB) or electromechanical service brake (EMB).

Alternatively, electrohydraulic brake force generators are known which, for example, build up a positive pressure in a sealed hydraulic system via a coaxial pump or piston pump. The pressurized hydraulic fluid of the hydraulic system is then guided to a delivery unit, for example a braking piston, which then actuates the brake pads.

Braking assemblies known from the prior art have a structure that requires a large amount of installation space. In addition, these braking assemblies have a complicated structure, thus resulting in high assembly costs.

### SUMMARY

What is needed is therefore to provide an electrically operated braking assembly which has a compact design, with a low manufacturing effort and at the same time can be produced economically.

An electrically operated braking assembly for a braking system of a motor vehicle, is disclosed, comprising a brake force generator and a control unit. The control unit is designed to control the brake force generator. The brake force generator has a brake force generator housing, to which a control housing, in which the control unit is accommodated, is attached directly adjacently to a side of the brake force generator housing. In addition, the brake force generator has an electric motor with a stator, wherein the stator is received, together with stator windings, in the control housing.

The basic concept of the disclosure is that the stator is received with the stator windings directly by the control housing, which in turn attaches directly to the brake force generator housing. In comparison to known braking assemblies from the prior art, installation space can thus be spared. In addition, due to the special arrangement of the stator, which is disposed in the immediate vicinity of the control unit, allows a simplified electrical cable routing from the stator windings to the control unit.

The braking assembly can either be formed here in such a way that it generates the braking force of a purely electromechanical brake, that is to say for example of a parking brake of a motor vehicle, or the braking force of an electrohydraulic brake, that is to say for example a service brake of a vehicle. Here, the structural design of the braking assembly differs primarily by the brake force generator used.

In one exemplary arrangement, the electric motor is a brushless DC motor (BLDC motor), which has an increased electrical wiring effort on account of the relatively more complex control. Specifically in the case of brushless DC motors, an advantage of the present disclosure is therefore particularly important, whereby the stator is placed in the immediate vicinity of the control unit, and so short electrical connection cables can be provided.

The stator is held only in the control housing. The control housing thus performs the function of a motor housing usually provided additionally to the control housing. Additional components can thus be spared, and the braking assembly can be constructed more compactly on the whole.

In accordance with an exemplary arrangement, the control housing is formed in a number of parts. It has a cover, in which the control unit lies, and an intermediate housing which lies between the cover and brake force generator housing and is attached to the brake force generator housing. The cover thus serves as a lateral cover in order to protect the control unit against dirt and other ambient influences. The intermediate housing itself lies here in a space-saving manner between the cover and the brake force generator housing.

The control unit can optionally be carried by the cover and thus positioned easily and in an exact manner on the intermediate housing. Alternatively, the control unit is carried by the intermediate housing so that the cover for example does not have to be centred on the intermediate housing in order to position the control unit in an exact manner on the intermediate housing.

In one exemplary arrangement, the stator is fastened to the intermediate housing. This allows a simple pre-assembly of the stator on the intermediate housing, so that the two components are present as a unit for further assembly of the braking assembly. The stator and control unit can additionally be arranged at two opposite ends of the intermediate housing, whereby the electrical connection cables of the stator, which reach as far as the control unit, can be made particularly short.

In accordance with one exemplary arrangement, a detent connection is formed at the intermediate housing and holds the stator, for example in the axial direction. Due to the detent connection, the stator can be held exactly in accordance with a predefined position on the intermediate housing. In one exemplary arrangement, the detent connection holds the stator exclusively in the axial direction, whereby the radial play/overdimension between stator and intermediate housing can be selected independently of the detent connection. As a result of the holding in the axial direction, a simple electrical contacting between stator and control unit can be achieved by a plugged connection, wherein the plug connection partners are connected in the axial direction and this connection is detachable without destruction.

One aspect of the disclosure provides that the detent connection has a plurality of axially protruding detent hooks, which protrude at the end face from a wall of the intermediate housing forming a receiving opening for the stator, for example in the direction of the brake force generator housing, and are formed resiliently radially outwardly. The detent hooks engage the stator and hold it in the axial direction. When assembling the stator and intermediate housing, the outwardly elastically resilient detent hooks are bent away from one another outwardly, so that the stator can be pushed into the intermediate housing. In contrast to a connection known from the prior art, for production of which the stator must be pressed into a hollow-cylindrical housing, the assembly can thus be performed without a great expenditure of force and without a separate fastening arrangement.

In accordance with a further exemplary arrangement, guide elements are distributed in the peripheral direction of the stator on the intermediate housing. Due to the guide elements, contact areas at specific points or in linear form are created between the guide elements and the stator. A radial clearance fit or press fit between the stator and the intermediate housing can be defined via the constructive dimensioning. Depending on the motor torque to be transferred, the guide elements can be dimensioned larger or also smaller in the radial and axial direction.

The detent hooks advantageously protrude into detent hook recesses of the brake force generator housing, wherein the detent hook recesses surround the detent hooks in the radial direction outwardly and laterally in the peripheral direction.

It can be provided that electrically conductive connection contact lugs starting from the stator protrude into an interior formed by the cover. The control unit can advantageously be accommodated in the interior in order to be protected optimally against external ambient influences. In order to achieve simple contacting of the stator at the control unit, the connection contact lugs protrude directly into the interior.

In one exemplary variant, guide openings for associated connection contact lugs are provided in a radial intermediate wall in the intermediate housing and the connection contact lugs extend through said guide openings to the control unit, where the connection contact lugs are electrically connected. With the aid of the guide openings, the connection contacts can be positioned in an exact manner in the intermediate housing, so that the connection contacts can be contacted spatially behind the exit from the guide openings precisely with the intended contact point of the control unit, provided the control unit has also been positioned in an exact manner on the intermediate housing, for example by a centring process.

In one exemplary arrangement, insertion bevels are provided at the guide openings on the side facing the stator in order further simplify the assembly of the connection contact lugs.

The guide openings are advantageously formed in the intermediate wall in integrally moulded sleeves, which protrude axially in the direction of the cover and form the protrusions for a printed circuit board of the control unit, wherein the printed circuit board has centring openings into which the protrusions protrude. Due to the protrusions, for example a printed circuit board secured to the cover can be positioned in an exact manner relative to the intermediate housing, wherein the axial positioning of the printed circuit board in the longitudinal direction of the guide openings is made possible via the dimensioning of the length of the sleeves.

In accordance with a further exemplary arrangement, the intermediate housing is pot-shaped and forms a base which is directly adjacent to the control unit. The intermediate housing is adapted to the shape of the stator in a space-saving manner on account of the pot shape. In addition, the base is ideally suitable for fastening a printed circuit board of the control unit to the base, in particular on a side of the base opposite the stator.

In one exemplary arrangement, the intermediate wall here can form the base.

In accordance with a further exemplary arrangement the stator protrudes into the brake force generator housing. An even more compact design can be created hereby, and for example a drive shaft of the brake force generator can be shortened.

### BRIEF DESCRIPTION OF DRAWINGS

The disclosure is described below with reference to various exemplary arrangement illustrated in the accompanying drawings. In the figures:

FIG. 1 shows a perspective view of an electrically operated braking assembly according to the disclosure in accordance an exemplary arrangement;

FIG. 2 shows the braking assembly from FIG. 1 in a sectional view, wherein parts of the brake force generator of the braking assembly are not shown;

FIG. 3 shows the braking assembly from FIG. 1 in a side view, wherein the brake force generator of the braking assembly is not shown;

FIG. 4 shows the braking assembly from FIG. 1 in a sectional view along the line IV-IV from FIG. 3;

FIG. 5 shows the detail V from FIG. 2 enlarged;

FIG. 6 shows an enlarged detail of a perspective view of the braking assembly from FIG. 1;

FIG. 7 shows an enlarged detail of a perspective view of the intermediate housing of the braking assembly from FIG. 1;

FIG. 8a shows an enlarged detail of a perspective view of the braking assembly from FIG. 1, wherein the stator of the braking assembly is not shown;

FIG. 8b shows an enlarged detail of a perspective view of the braking assembly from FIG. 1; and

FIG. 9 shows the brake force generator housing of the braking assembly from FIG. 1 in a perspective view.

### DETAILED DESCRIPTION

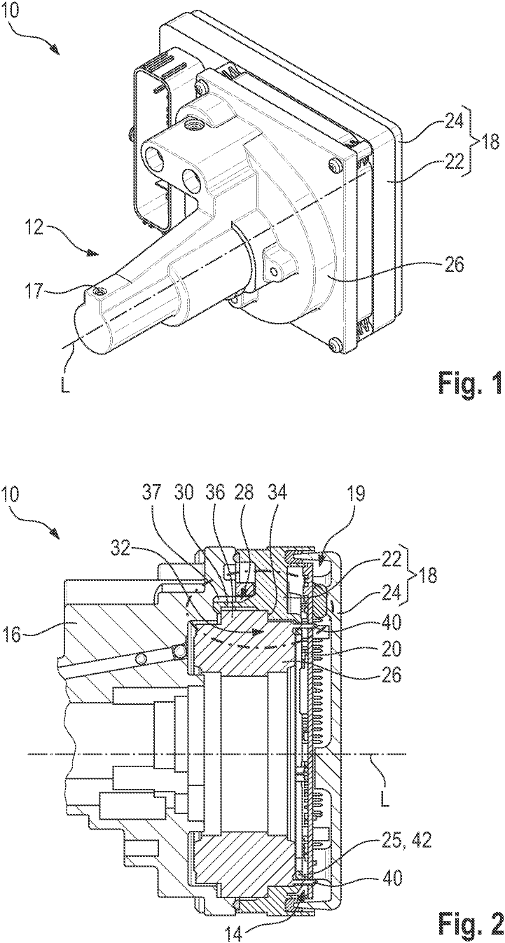

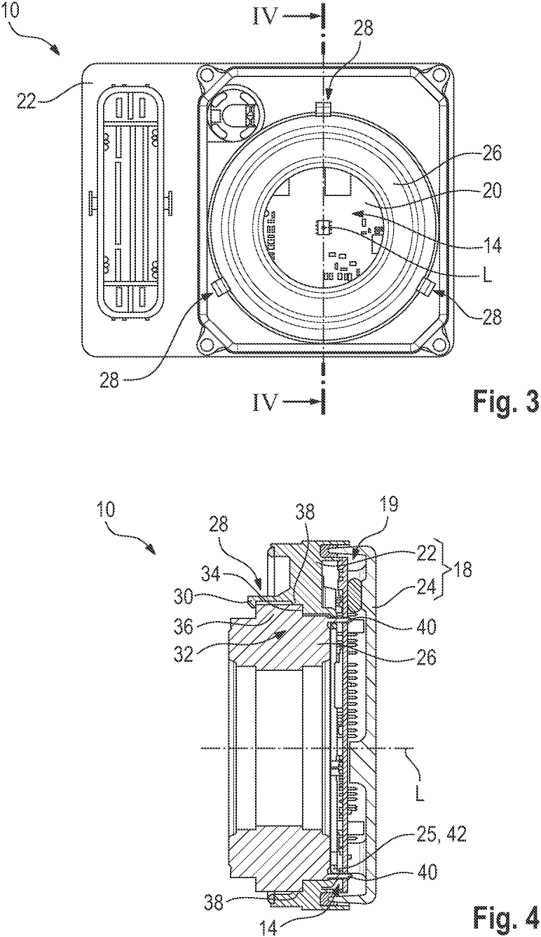

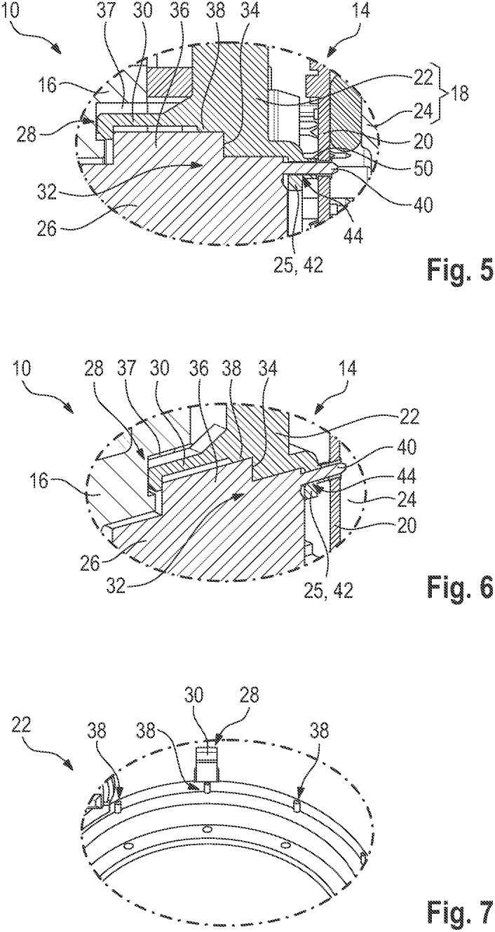

An electrically operated braking assembly 10 for a braking system of a motor vehicle is shown in FIGS. 1 to 6.

The braking assembly 10 is embodied here as an electrohydraulic braking assembly 10 and serves, for example as the result of actuation of a brake pedal in a motor vehicle, to build up a desired positive pressure in a hydraulic system filled with a hydraulic fluid and to thus actuate a vehicle brake.

The pressurized hydraulic fluid in this case actuates a brake piston of a tensioning unit of a vehicle brake, wherein the piston presses brake pads against a brake disc connected to a vehicle wheel, thus slowing down the wheel.

The braking assembly 10 has a hydraulic brake force generator 12 and an electronic control unit 14 (see FIGS. 1 and 2). The brake force generator 12 can be controlled by the control unit 14.

The brake force generator 12 has a brake force generator housing 16, which for example received a spindle drive with an electric motor.

The spindle drive engages a piston, by which the volume of a liquid cavity inside the brake force generator housing 16 can be changed, thus controlling the pressure in the hydraulic system. By reducing the volume, a positive pressure can be generated reversibly in the hydraulic system and is reduced again when the volume is increased once more.

The positive pressure of the hydraulic fluid in the otherwise sealed fluid cavity can be conveyed via hydraulic lines to the delivery unit of the brake via an opening 17 in the brake force generator housing 16.

The electric motor is a brushless DC motor (BLDC motor), which requires relatively complex control by the control unit 14.

The control unit 14 is surrounded by a control housing 18, which receives the control unit 14 in an interior 19 of the control housing 18.

More precisely, the control unit 14 has a printed circuit board 20 which is received in the interior 19 (see FIG. 2).

The control housing 18 is embodied in a number of parts, here for example in two parts, and besides an intermediate housing 22 comprises a cover 24, wherein the cover 24 is fastened fixedly to the intermediate housing 22.

The intermediate housing 22 directly adjoins the brake force generator housing 16 and is fixedly connected thereto.

In addition, the intermediate housing 22 is pot-shaped and has a base 25. The intermediate housing 22 id directly adjacent to the control unit 14, for example by the base 25.

The cover 24 is disposed on a side of the intermediate housing 22 opposite the brake force generator housing 16. The cover 24 thus protects the control unit 14 and closes the interior 19, so that this is completely sealed with respect to its environment.

The printed circuit board 20 of the control unit 14 is fastened to the cover 24.

Alternatively, however, the printed circuit board 20 could also be fastened directly to the intermediate housing 22, for example, to the base 25.

To position the printed circuit board 20 in an exact manner on the intermediate housing 22, the cover 24 is additionally centred on the intermediate housing 22.

The brake force generator housing 16 and the intermediate housing 22 receive a stator 26 of the electric motor, that is to say the stator 26 inclusive of stator windings.

Here, the stator 26 protrudes into the brake force generator housing 16, whereby a compact design is achieved.

The stator 26 is held here exclusively in the control housing 18.

More precisely, the stator 26 is fastened exclusively to the intermediate housing 22.

For this purpose, a detent connection 28 is provided on the intermediate housing 22 and holds the stator 26 in the axial direction along the longitudinal axis L of the braking assembly 10.

The detent connection 28 is formed by a plurality of axially protruding detent hooks 30, which at the free ends have a hook with a contact surface.

In addition, the detent hooks 30 are thin and elongate, so that they are elastically resilient outwardly in the radial direction of the intermediate housing 22.

The detent hooks 30 protrude at the end face on a wall 34 of the intermediate housing 22 forming a receiving opening 32 for the stator 26.

Here, the wall 34 serves at the same time as an axial stop for the stator 26.

The stator 26 has a collar 36 with enlarged outer diameter which bears at its axial side faces on the one hand against the wall 34 and on the other hand against the detent hook 30, wherein the collar 36 is thus clamped.

The detent hooks 30 protrude into detent hook recesses 37 of the brake force generator housing 16 which surround the detent hooks 30 in radial direction outwardly and laterally in the peripheral direction (see FIGS. 2, 5, 6 and 9).

As can be seen from FIG. 7, guide elements 38 are integrally moulded in a distributed fashion on the intermediate housing 22 in the radial peripheral direction of the stator 26 and the dimensioning of said guide elements allows a defined radial play or a defined radial press fit between the stator 26 and the intermediate housing 22 to be defined constructively (see FIGS. 4 to 7).

Due to the guide elements 38, contact areas in linear form are created between the guide elements 38 and the stator 26.

With the presence of a radial press fit between the guide elements 38 and the stator 26, the contact surfaces, which are discontinuous in the peripheral direction, facilitate the joining of the stator 26 to the intermediate housing 22, since the contact surfaces are not formed continuously as a single, radially peripheral contact surface, thus reducing the friction.

In the present case, a slight press fit has been selected in order to transfer the reaction torque from the stator 26 to the intermediate housing 22.

The stator 24 additionally has connection contact lugs 40, which protrude from the stator 26. The stator windings of the stator are supplied with current via the connection contact lugs 40, wherein the supplied current is controlled by the control unit 14.

The connection contact lugs 40 extend through the intermediate housing 22 into the interior 19 (see FIG. 2).

Here, guide openings 44 for receiving connection contact lugs 40 are provided in a radial intermediate wall 42, here in the base 25, of the intermediate housing 22.

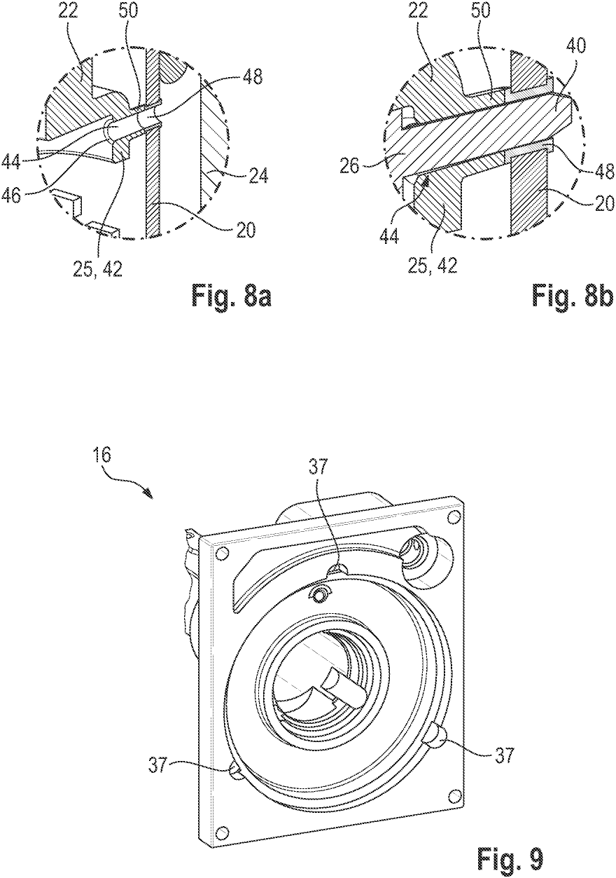

The connection contact lugs 40 extend through the guide openings 44 to the printed circuit board 20 of the control unit 14, where they are connected electrically to the printed circuit board 20 (see FIGS. 8a and 8b).

In order to be able to introduce the connection contact lugs 40 more easily into the guide openings 44 during the assembly process, insertion bevels 46 are provided on the guide openings 44 on the side of the intermediate housing 22 facing the stator windings of the stator 26 (see FIG. 8a).

In addition, electrical contact sockets 48 are provided in the printed circuit board 20 and the connection contact lugs 40 are plugged into said contact sockets in a manner such that they can be detached without destruction.

The contact sockets 48 are in turn embedded fixedly in the printed circuit board 20, but could alternatively also be pressed fixedly into the printed circuit board 20 for example (see FIGS. 8a and 8b).

The guide openings 44 on the one hand run through the intermediate wall 42 and on the other hand through sleeves 50 integrally moulded on the rear side of the intermediate wall 42.

The sleeves 50 protrude in the axial direction from the intermediate wall 42 in the direction of the printed circuit board 20 and thus form protrusions for the printed circuit board 20.

1. An electrically operated braking assembly for a braking system of a motor vehicle, comprising a brake force generator and a control unit, which controls the brake force generator wherein the brake force generator has a brake force generator housing, to which a control housing, in which the control unit is accommodated, is attached directly adjacently to a side of the brake force generator housing, and wherein the brake force generator has an electric motor with a stator and the stator is received, together with stator windings, in the control housing.

2. The electrically operated braking assembly according to claim 1, wherein the stator is held only in the control housing.

3. The electrically operated braking assembly according to claim 1, wherein the control housing is formed in a number of parts, with a cover, in which the control unit lies, and an intermediate housing which lies between the cover and the brake force generator housing and is attached to the brake force generator housing.

4. The electrically operated braking assembly according to claim 3, wherein the stator is fastened to the intermediate housing.

5. The electrically operated braking assembly according to claim 4, wherein a detent connection is formed on the intermediate housing and holds the stator, in the axial direction.

6. The electrically operated braking assembly according to claim 5, wherein the detent connection has a plurality of axially protruding detent hooks, which protrude at the end face from a wall of the intermediate housing forming a receiving opening for the stator, in the direction of the brake force generator housing, and are formed resiliently radially outwardly.

7. The electrically operated braking assembly according to claim 3, wherein electrically conductive connection contact lugs starting from the stator protrude into an interior formed by the cover.

8. The electrically operated braking assembly according to claim 7, wherein guide openings (for associated connection contact lugs are provided in a radial intermediate wall in the intermediate housing and the connection contact lugs extend through said guide openings to the control unit, where the connection contact lugs are electrically connected.

9. The electrically operated braking assembly according to claim 8, wherein the guide openings are formed in the intermediate wall in integrally moulded sleeves, which protrude axially in a direction of the cover and form the protrusions for a printed circuit board of the control unit, wherein the printed circuit board has centring openings into which the protrusions protrude.

10. The electrically operated braking assembly according to claim 3, wherein the intermediate housing is pot-shaped and forms a base which is directly adjacent to the control unit.

11. The electrically operated braking assembly according to claim 1, wherein the stator protrudes into the brake force generator housing.

12. The electrically operated braking assembly according to claim 2, wherein the control housing is formed in a number of parts, with a cover, in which the control unit lies, and an intermediate housing which lies between the cover and the brake force generator housing and is attached to the brake force generator housing.

13. The electrically operated braking assembly according to claim 12, wherein the stator is fastened to the intermediate housing.

14. The electrically operated braking assembly according to claim 13, wherein a detent connection is formed on the intermediate housing and holds the stator, in the axial direction.

15. The electrically operated braking assembly according to claim 14, wherein the detent connection has a plurality of axially protruding detent hooks, which protrude at the end face from a wall of the intermediate housing forming a receiving opening for the stator, in the direction of the brake force generator housing, and are formed resiliently radially outwardly.

16. The electrically operated braking assembly according to claim 12, wherein electrically conductive connection contact lugs starting from the stator protrude into an interior formed by the cover.

17. The electrically operated braking assembly according to claim 16, wherein guide openings for associated connection contact lugs are provided in a radial intermediate wall in the intermediate housing and the connection contact lugs extend through said guide openings to the control unit, where the connection contact lugs are electrically connected.

18. The electrically operated braking assembly according to claim 17, wherein the guide openings are formed in the intermediate wall in integrally moulded sleeves, which protrude axially in a direction of the cover and form the protrusions for a printed circuit board of the control unit, wherein the printed circuit board has centring openings into which the protrusions protrude.

19. The electrically operated braking assembly according to claim 12, wherein the intermediate housing is pot-shaped and forms a base which is directly adjacent to the control unit.

20. The electrically operated braking assembly according to claim 12, wherein the stator protrudes into the brake force generator housing.
